(19) United States
(12) Patent Application Publication
(10) Pub. No.: US 2006/0134577 A1
(43) Pub. Date: Jun. 22, 2006

(54) Dental polymerization light transmission instrument

(76) Inventor: Michael Yar Zuk, Red Deer (CA)

Correspondence Address: Dr. Michael Y. Zuk, 102 Allison Cres., Red Deer, AB, T4R 2G9, CA

(21) Appl. No.: 11/018,659

(22) Filed: Dec. 22, 2004

(51) Int. Cl. A61C 3/00

(52) U.S. Cl. 433/29

(57) ABSTRACT

A dental polymerization light transmission instrument is described for the use in simplifying the cementation of indirect cosmetic dental restorations that are secured into position with light cured composite cement. The invention teaches a method where light derived from dental light units utilizing standard curing tips may be directed through an unattached instrument which allows the dentist to control the position of the dental restoration and reduce the complexity and risks involved in the removal of excess cement prior to the final cement cure.

### FIELD OF THE INVENTION

A light transmission instrument and method of use is described for providing the dentist a method which allows the rapid cementation of porcelain or indirect composite veneers and crowns to a patient's teeth. The invention teaches the application of the instrument to allow the light from a dental curing light to be directed through an independent device which allows the light to be focused on a small area on the surface of the veneer or crown which cures the cement in this localized area and allows the excess cement to be removed prior to a final cure without disturbing the position of the dental restoration.

### BACKGROUND OF THE INVENTION

Composite cement is the primary cementing agent used to adhere laboratory processed or “indirect” dental restorations. In situations where the dental restoration allows light to transmit through the material, the dentist is afforded the ability to control the setting time of the cement if a light cured cement is selected.

The general procedural steps commonly employed in adhering an indirect restoration to a tooth surface involves preparing the tooth surface and the inside of the dental restoration in a way which increases the adherence of the cement and bind the two together. This usually involves acid etching the surfaces that will be cemented together and applying selected bonding agents that allow the cement to better adhere to the surfaces involved. The cement has an effect on the restoration's aesthetics, strength, resistance to deterioration and patient sensitivity.

Once the involved surfaces are prepared, the cement is applied and the restoration is positioned on the tooth. Excess cement is desired as any deficiencies would result in a void under the restoration which is undesirable. The point in time where the fragile restoration is floating in unset cement on the tooth does not allow the dentist the ability to easily remove the excess cement without the risk of moving the restoration out of position or inadvertently allowing air bubbles to seep back under the edges of the restoration creating the voids. A technique exists which involves using a curing light tip that focuses the curing light on the small central area of the restoration which allows the dentist to control the area of cement polymerization and tack the restoration in place.

Once the restoration is held in place by this small area of cured composite cement, the dentist may safely remove the excess cement with floss or other instruments without the risk of losing the position, allowing air to seep under the restoration, or getting excess cement hardened between the teeth which is extremely difficult to remove. The curing light tips presently used for the purpose of focusing the light for use in the technique described above are attached to the curing light unit and are fragile and expensive. This technique also involves removing the regular curing tip and then replacing it with the small tip and attempting to steady the curing light into the proper position without disturbing the position of the restoration.

Accordingly, there is a need for a device that is separate from the curing light which allows the dentist to redirect the dental polymerization light to the desired location on the restoration, usually with a light amount of pressure to fully seat the restoration, and then permits the assistant to position the traditional light curing tip in a way which directs the light through the separate device allowing the restoration to be tacked into position.

A review of the art reveals a similar device has not been developed. For example, all the small curing tips available for the technique described are attached directly to the dental curing light which has serious limitations already mentioned. An invention with some common features with the one proposed is used to direct the light separately from the curing unit for use in forming contacts between the teeth when placing direct composites. This device does not prevent the scattered light from the tip which would have a negative effect on the use described for the present invention by the inadvertent curing of the cement in adjacent areas to those desired. Further, the device used to form contacts with direct restorations processes a tip which does not direct the light in such a way as to be effective with the technique described for indirect restorations.

### SUMMARY OF THE INVENTION

In accordance with the invention, there is provided an appliance that comprises a handle and two functional tips at each end of the handle which are employed for the direction and control of light transmission from a separate dental curing light used to cure dental composite restorations and cements based on this technology. Specifically this appliance is used in the cementation of indirectly fabricated cosmetic dental restorations.

In a specific embodiment, the device is fabricated out of clear plastic and selectively coated with an opaque or orange surface which blocks the specific wavelengths involved in the polymerization of the composite cement. The opaque coating is not included in the areas of the functional tips involved in light transmission, which may be referred to as the receiving lens and the focal lens which are part of a single unit which transmits the light from the light curing tip and focuses it in a specific area. The receiving side of the functional tip is large enough to capture the end of most standard curing light tips (approximately 13 mm in diameter), and in this embodiment has a flange that reduces lateral light transmission and helps to center the light tip over the receiving lens. The receiving lens may be flat or convex to assist in focusing the light through the function tip. The focal lens, where the light exits the appliance, is a smaller diameter and may be of two sizes to better adapt to assorted tooth dimensions. In addition, this lens may be flat or concave to adapt to the natural curvature of the restoration that is being cemented into place. The body of the functional tip is coated with the opaque coating or a coating that changes the wavelength of the light into one which does not polymerize the composite resin.

In another form of the invention, the functional tips may be removable and replaced when worn or affected negatively by sterilization protocols. If they are separate from the handle, a material like glass may be employed. The tips may also be angled in relation to the handle in assorted configurations to aid in positioning for operator preference.

In a further embodiment, the functional tips may use a disposable cover to aid in the reduction of light transmission from the body of the tips. This would help to reduce problems when the opaque coating became scratched or perforated due to multiple uses and handling during sterilization.

### DESCRIPTION OF THE DRAWINGS

These and other features of the invention are described with reference to the drawings wherein;

FIG. 1 is a sketch of the appliance from a lateral perspective;

FIG. 2 is a sketch of the appliance from a superior perspective;

FIG. 3 is a sketch of the appliance being used in a clinical application.

### DETAILED DESCRIPTION OF THE INVENTION

With reference to the figures, a device used to direct light transmission for the polymerization of composite cements used in adhesion of indirect cosmetic dental restorations is described.

In the process of securing an indirect cosmetic dental restoration, a popular choice of material for cementation is light-cured composite resin cement. This material may be manipulated for an extended period of time if it is shielded from certain wavelengths of visible light in the blue range. This allows the dentist time to place the cement inside the restoration and position the restoration where desired. When it is time to harden the cement, the dentist often has a problem removing excess cement prior to the setting stage or risks disturbing the position of the restoration in the process if the cement is not set enough to resist the forces involved.

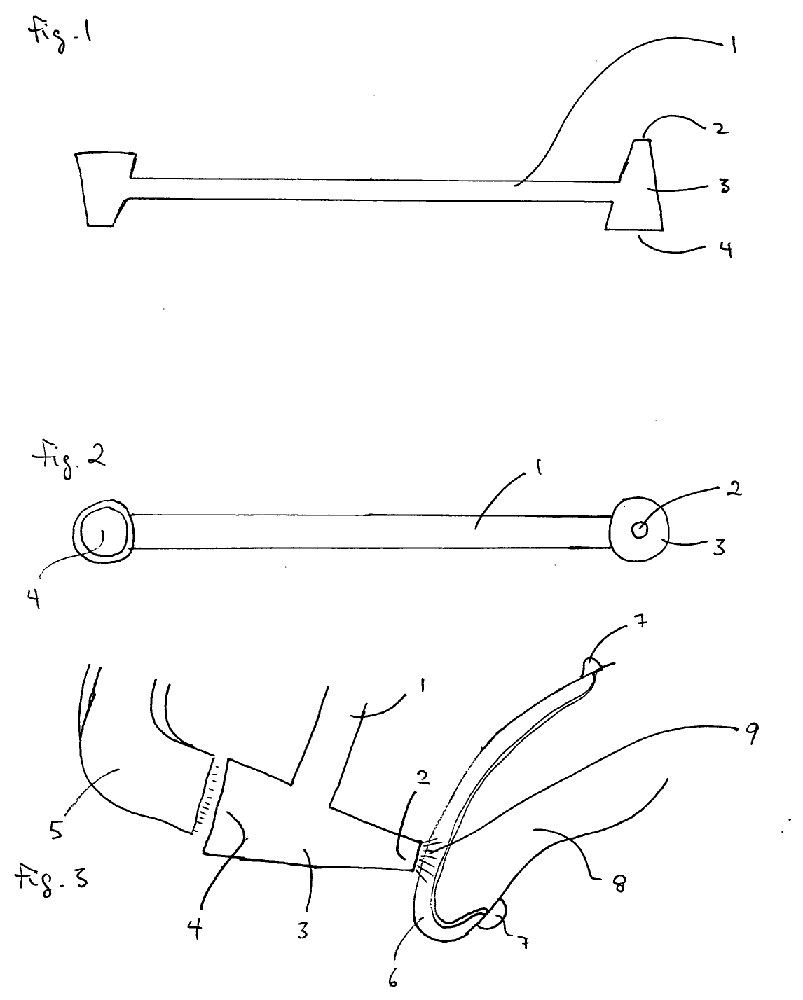

In accordance with the invention, the restoration (#6, FIG. 3) is seated on a tooth (#8, FIG. 3) and it is noted some cement expresses out from under the restoration (#7, FIG. 3). The device described as the dental polymerization light transmission instrument is positioned by the dentist holding the handle (#1, FIG. 1) so that the smaller, focal lens (#2, FIG. 3) is pressed lightly against the restoration to ensure complete seating against the tooth and to express excess cement.

The body of the functional tip (#3, FIG. 3) is coated with a material that does not allow transmission of the light waves involved in polymerization of the composite cement. At this point the dental assistant directs the tip of the dental curing light (#5 FIG. 3) against the receiving lens (#4 FIG. 3) of the transmission instrument and upon instruction from the dentist activates the curing light for the desired time interval.

The curing light provides a light source that is designed to activate the polymerization process and harden the composite cement. The light generated passes through the glass tip of the curing light and into receiving lens of the dental polymerization light transmission instrument and out through the small focal lens which is positioned against the dental restoration. The dental restoration (#9, FIG. 3) is semi-translucent and allows the light to reach the inside surface where the cement is hardened in the localized area exposed to the light. This process tacks the restoration in place and allows the excess cement (#7 FIG. 3) to then be removed without disturbing the position of the restoration.

Once the excess cement is removed with floss or by other methods, the curing light is used directly on the dental restoration without the aid of the transmission instrument. This completes the cure of the cement in the remaining areas under the restoration without the need to change tips on the curing unit.

1. A dental polymerization light transmission instrument that is used in conjunction with but not attached in any way to the light curing unit which is an independent light source and is used to direct and focus the light emitted in the process of cementing an indirect dental restoration.

2. The appliance as in claim 1 where the functional tips may be used to direct the light from a dental light unit through to the desired location on the surface of a dental restoration.

3. The appliance in claim 1 where the device has a coating on the body of the functional tip that eliminates or substantially reduces the wavelengths that polymerize composite resin. The light absorbing coating covers the main body of the functional tip and specifically excludes the receiving and focal lens areas.
